(19) United States
(12) Patent Application Publication
(10) Pub. No.: US 2026/0213431 A1
(43) Pub. Date: Jul. 23, 2026

(54) HYBRID INSULATION PIERCING CONNECTORS

(71) Applicant: Hubbell Incorporated, Shelton, CT (US)

(72) Inventor: Richard Robicheau, Litchfield, NH (US)

(21) Appl. No.: 19/454,996

(22) Filed: Jan. 21, 2026

Related U.S. Application Data
(60) Provisional application No. 63/748,047, filed on Jan. 22, 2025.
(60) Provisional application No. 63/808,165, filed on May 19, 2025.

(51) Int. Cl. H01R 4/2466; H01R 4/2479

(52) U.S. Cl. CPC H01R 4/2466; H01R 4/2479

(57) ABSTRACT

An electrical connector for connecting a plurality of conductors includes a conductor block having a body with a run line opening. A run insulation piercing member extends into the run line opening. A run cap extends over the run line opening. A run bolt extends through the run cap into the run line opening. A tap line block is connected to the conductor block. The tap line block includes a tap body and a tap line opening extending at least partially through the tap body. At least a portion of the tap body is configured to be deformed to crimp a tap conductor to the tap line block.

### RELATED APPLICATION(S)

This application is based on U.S. Provisional Application Ser. No. 63/748,047, filed Jan. 22, 2025 and U.S. Provisional Application Ser. No. 638/808,165, filed May 19, 2025, the disclosures of which are incorporated herein by reference in their entirety and to which priority is claimed.

### FIELD

The present disclosure relates to electrical connectors used to connect a main or run conductor with one or more tap conductors.

### BACKGROUND

Electrical connectors exist in various forms including terminals, splices and run and taps. Tap connectors can be used to establish an electrical connection between a continuous run or main power conductor to a tap or branch conductor. Existing compression connectors are typically adapted to receive a branch or tap conductor, to engage a continuous run conductor, and to be compressed by means of a crimping tool to achieve the desired connection.

Compression connectors can include insulation piercing teeth that will pierce the non-conductive, outer insulation layer of a conductor to contact the inner core. The core can be a solid or stranded wire made from an electrically conductive material. Use of insulation piercing teeth can reduce or eliminate the need to strip conductors prior to making a connection and eliminate the need to secure connections with a joining material such as solder.

### SUMMARY

Certain configurations are directed to a connector for making multi-tap connections using both compression and mechanical connections.

In certain configurations, a connector can include a connector body having a compressible portion and a mechanical connection portion.

In certain configurations, an electrical connector for connecting a plurality of conductors includes a conductor block having a body with a run line opening. A run insulation piercing member extends into the run line opening. A run cap extends over the run line opening. A run bolt extends through the run cap into the run line opening. A tap line block is connected to the conductor block. The tap line block includes a tap body and a tap line opening extending at least partially through the tap body. At least a portion of the tap body is configured to be deformed to crimp a tap conductor to the tap line block.

In certain configurations, an electrical connector for connecting a plurality of conductors includes a conductor block having a body with a run line opening. A run insulation piercing member extends into the run line opening. A run cap extends over the run line opening. A run bolt extends through the run cap into the run line opening. A tap line block is connected to the conductor block. The tap line block is slidably connected to the conductor block. The tap line block includes a tap body and a tap line opening extending at least partially through the tap body. At least a portion of the tap body is configured to be deformed to crimp a tap conductor to the tap line block.

In certain configurations, an electrical connector for connecting a plurality of conductors includes a compression connector having a body with a run line opening. A run insulation piercing member extends into the run line opening. A tap line block is slidably connected to the compression connector. The tap line block has a tap body and a tap line opening extending at least partially through the tap body. At least a portion of the tap body is configured to be deformed to crimp a tap conductor to the tap line block.

In certain configurations, an electrical connector for connecting a plurality of conductors includes a conductor block having a body with a run line opening. A run insulation piercing member extends into the run line opening. A run cap extends over the run line opening. A run bolt extends through the run cap into the run line opening. A tap line block is connected to the conductor block. The tap line block is slidably connected to the conductor block. The tap line block includes a tap body, a tap line opening extending at least partially through the tap body, and a tap insulation piercing member extending into the tap line opening. At least a portion of the tap body is configured to be deformed to crimp a tap conductor to the tap line block.

In certain implementations, a method of electrically connecting a plurality of conductors includes inserting a tap conductor into a tap conductor opening of a tap line block. The tap line block is crimped to secure the tap conductor. The tap line block is connected to a conductor block having a run line opening. A run conductor is inserted into the run line opening of the conductor block. A run bolt is rotated to engage the run conductor. The run conductor is driven into a run insulation piercing member extending into the run line opening. The run bolt is rotated until a second torque limit is reached and a head of the run bolt is sheared off.

### BRIEF DESCRIPTION OF THE DRAWINGS

The following drawings depict exemplary configurations and implementations of the inventive concepts of the disclosure.

FIG. 1 is a perspective view of a multi-tap compression connector, run conductor, and tap conductors.

FIG. 2 is a front view of the connector of FIG. 1.

FIG. 3 is a perspective view of another multi-tap compression connector with removable insulation piercing members.

FIG. 4 is a front view of the connector of FIG. 4.

FIG. 5 is a perspective view of another multi-tap connector with mechanical securement members.

FIG. 6 is a front view of the connector of FIG. 5.

FIG. 7 is a top view of the connector of FIG. 5.

FIG. 8 is a front, exploded view of the connector of FIG. 5.

FIG. 9 is a front, exploded view of a multi-tap connector with a mechanical run connector and a tap compression connector.

FIG. 10 is a front view of the connector of FIG. 9.

FIG. 11 is a front view of the tap line connector of FIG. 9 in a compression die.

FIG. 12 is a perspective view of another exemplary configuration of a multi-tap electrical connector.

FIG. 13 is a front view of another exemplary tap line block.

FIG. 14 is a perspective view of another exemplary configuration of a multi-tap electrical connector.

FIG. 15 is a perspective view of another exemplary configuration of a multi-tap electrical connector.

FIG. 16 is a front view of another exemplary tap line block.

FIG. 17 is a perspective view of another exemplary configuration of a multi-tap electrical connector.

### DETAILED DESCRIPTION OF EXEMPLARY EMBODIMENTS

Tap connectors are used in different electrical distribution applications. Tap connectors are used to transfer electrical power between one or more conductors. For example, a primary, main, or run conductor and one or more secondary, branch, or tap conductors are physically and electrically connected, such as a distribution block, terminal lug, splice, or other connector. Power is transferred between the primary conductor and the tap conductors.

For example, tap conductors can be used in solar power generation facilities to help distribute power from individual solar panels to a main trunk line. Each panel or an array of panels can generate power which is fed to a junction box. Conductors are run from the junction box and can be connected to a combiner box. The combiner box combines the electrical outputs from multiple strings of panels into a single output. The main trunk line, also known as the bus bar, is a heavy-duty cable or set of cables that runs along the rows of solar panels. It collects the combined electrical output from all the parallel strings in the array. The trunk line typically carries the DC electricity to a central location, such as an inverter station or a substation, for further processing or distribution. The inverter converts the DC electricity from the solar panels into AC electricity suitable for grid connection or use in a local network.

As demand for solar power grows, installations generating solar power are trending toward larger footprints and larger production capacity. However, scaling solar farm capacity also grows complexity. Costs associated with installation, operation, and maintenance grow. Field terrain and other factors can challenge photovoltaic module layouts, requiring flexibility for connecting these installations. Accordingly, being able to produce flexible, repeatable, and reliable connections in a distribution system, such as a solar farm, offers a number of benefits.

Certain implementations are directed to connectors that are configured to connect a run line to multiple tap lines. Certain configurations can utilize insulation piercing teeth in one or both of the run lines and tap lines so that the need to strip conductors prior to installation is reduced or eliminated. Compression connectors with insulation piercing teeth are described in U.S. application Ser. No. 18/211,102, published as US 2023/0411871, the disclosure of which is hereby incorporated by reference in its entirety.

Run conductors are typically greater in size than the tap conductors. The run conductors and the tap conductors can be solid conductors, or they can be stranded conductors. Typically, the run conductors and tap conductors are stranded conductors. different sizes and types of conductors can be used.

Further, while the terms run/main/trunk conductors and secondary/tap/branch conductors may be used, the connectors described are suitable for mechanically and electrically joining any one conductor to any one or more other conductors regardless of the type of conductor or implementation of the power system.

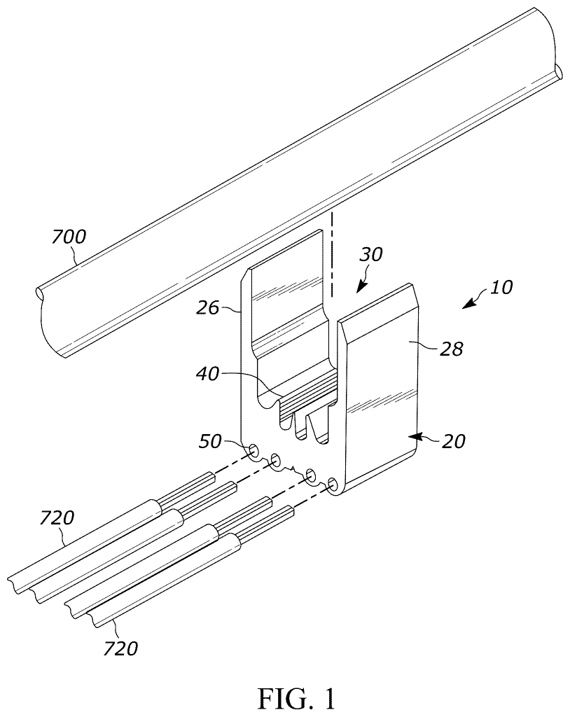

FIGS. 1-4 shows an exemplary configuration of a connector 10 a body 20 having a run conductor portion 22 and a tap conductor portion 24. The run conductor portion 22 includes two side walls 26 and 28 and a bottom wall 32 between the two side walls 26 and 28 that form or define a portion of a run opening 30.

The thickness of one or both of the walls 26 and 28 can vary along a length L of the connector. For example, the walls 26, 28 can have a first thickness “T1” along a first portion of the wall 26, and a second thickness “T2” along a second portion of the wall 26, where the first thickness “T1” is greater than the second thickness “T2.” A transition zone 26a, 28a from the first portion of the walls 26, 28 to the second portion of the walls 26, 28 may be a sharp transition zone or a smooth transition zone.

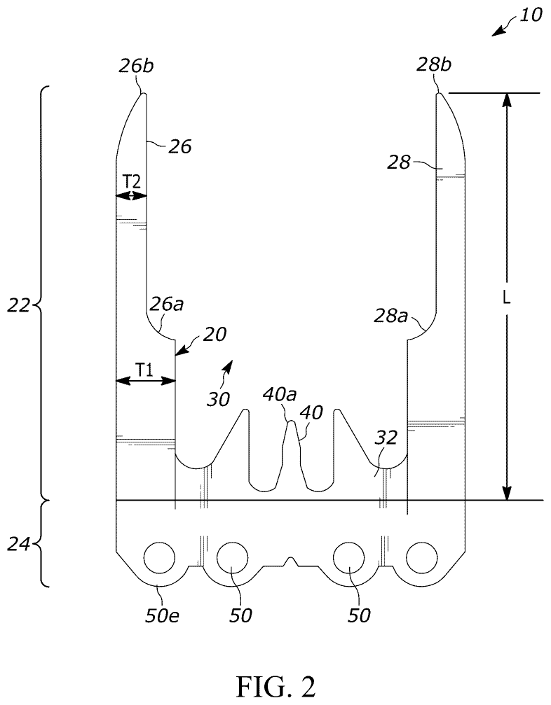

The run conductor portion 22 of connector 10 is substantially a U-shaped like structure with the first portion of the walls 26 and 28 and the bottom wall 32 being configured so that the run opening 30 can receive a run conductor. The length of the side walls 26, 28 and the bottom wall 32 can be modified to fit different sizes or ranges of run conductors. In the exemplary configurations shown in FIGS. 1 and 2, the

The bottom wall 32 can include one or more insulation piercing members 40 that extend into the run opening 30. Each insulation piercing member 40 includes an insulation piercing tip 40a that is configured and dimensioned to pierce or cut through the insulating jacket of the run conductor 700 to create an electrical path between the run conductor and the connector.

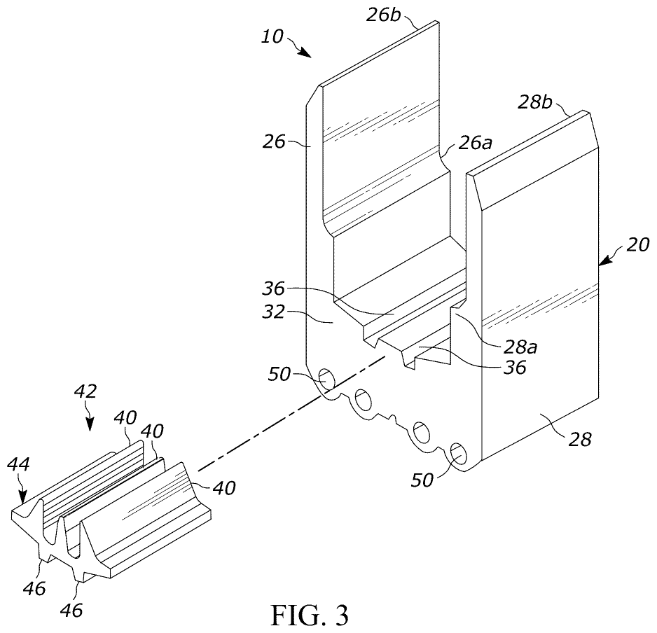

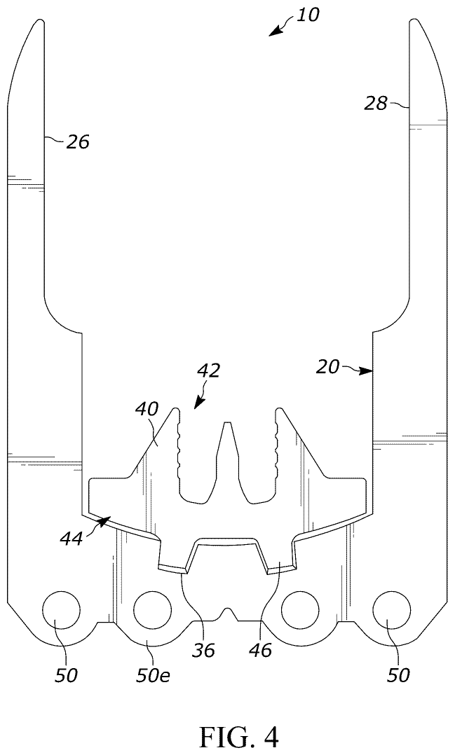

In certain configurations, the insulation piercing members 40 may be integrally or monolithically formed into the bottom wall 32 such that the one or more insulation piercing members 40 extend into the run opening 30 as shown in FIGS. 1 and 2. In other configurations, as shown in FIGS. 3 and 4, the one or more insulation piercing members 40 may be attachable to the body 20 of connector 10.

In certain configurations, the insulation piercing members 40 may be made from a different material than the body 20. For example, portions of the body 20 of connector 10 need to be pliable and move during a compression process and may be made of a relatively soft material such as, for example, from tin-plated copper, aluminum or similar metallic materials which would appropriately deform when pressure is applied in standard mechanical, hydraulic and pneumatic crimping tools and devices to crimp the conductors to the connectors. On the other hand, performance of the insulation piercing members 40 may be improved by using a relatively harder material. Accordingly, the one or more insulation piercing members 40 may be made from a different material (e.g., copper, tempered aluminum, stainless steel, etc.) and secured to or attached to the bottom wall 32 of connector 10 so that the one or more insulation piercing members 40 extend into the run opening 30.

In the configuration of FIGS. 3 and 4, the insulation piercing members 40 can be part of an insulation piercing assembly 42 that can be mounted or secured to the body 20 of the connector As an example, the insulation piercing assembly 42 may have a body 44 with one or more insulation piercing members 40 extending from an upper surface of the body 44 and one or more mounting ribs 46 extending from a bottom surface of the body 44. The one or more mounting ribs 46 are configured and dimensioned to fit with one or more mounting channels 36 in the bottom wall 32 of the body 20. It is noted that alternatively or in addition, one or more mounting ribs 46 can be provided on the bottom wall 32 of the body 20 and be configured and dimensioned to fit with one or more mounting channels 36 in the bottom surface of the body 44. It is also noted that one or more insulation piercing members 40 may extend from an inner surface of one or more walls 26 and 28.

The tap connector portion 24 can include one or more raised semicircular regions or bumps 50e which extend downward therefrom and may extend partly or completely along the width of connector 10. One or more tap conductor openings 50 are formed above each semicircular region 50e. A portion of each tap conductor opening 50 can be configured and dimensioned to receive one or more tap conductors. In the illustrated configuration, the tap conductor portion 24 includes four tap conductor openings 50. Each tap conductor opening 50 extends along the width of the body 20 as shown. In this configuration, when the connector 10 is crimped or compressed, the semicircular regions fold, bend or deform upward to close openings 50 and crimp a tap conductor in the tap opening 50.

During installation, the connector can be placed into a tool, such as a hydraulic power tool, between a pair of dies. A run conductor 700 is positioned in the run opening 30 of the connector 10, and end portions of the tap conductors 720 are stripped and are positioned in the branch openings 50 of the connector 10 (before or after positioning the connector in the tool). When the tool is actuated, the dies will deform the walls 26, 28 of the connector 10 to secure the run conductor and to drive the tips of the one or more insulation piercing members 40 of the connector 10 through the insulating jacket surrounding the electrical wire of the run conductor 700, creating electrically conductive paths between the run conductor 700 and the connector 10. In addition, as the tool is compressing the connector 10, the tap openings 50 are compressed to secure the tap conductors 720.

In certain configurations, instead of using compressible connectors to secure the conductors, the connections can be secured by shear bolt connectors. The shear bolt can include a head connected to a threaded shaft by a shearable section. The shearable section can be a weakened area designed to break or otherwise separate once a certain torque limit is reached. At the fastener is rotated, the shaft or an associated pressure bar will engage a conductor. As the fastener is tightened, the engagement with the conductor will increase the amount of torque required to further turn the fastener. Once the torque limit is reached, the head with shear, separating from the fastener. This ensures a certain connection engagement is achieved with the conductor, while also preventing overtightening that could damage the conductor.

Use of shear bolt connectors can be accomplished with standard tooling, such as an electric impact driver. This can eliminate the need to use more complex tooling, such as a power crimping tool, which can be heavier and more expensive.

Use of these types of connectors can provide a number of advantages. In any electrical distribution system that can increase the flexibility of the system design and reduce the need for complex tooling and installation procedures. They can increase the repeatability and reliability of connections. In solar panel installations they can also eliminate the need for combiner boxes, allowing panels to be more directly connected to a trunk line.

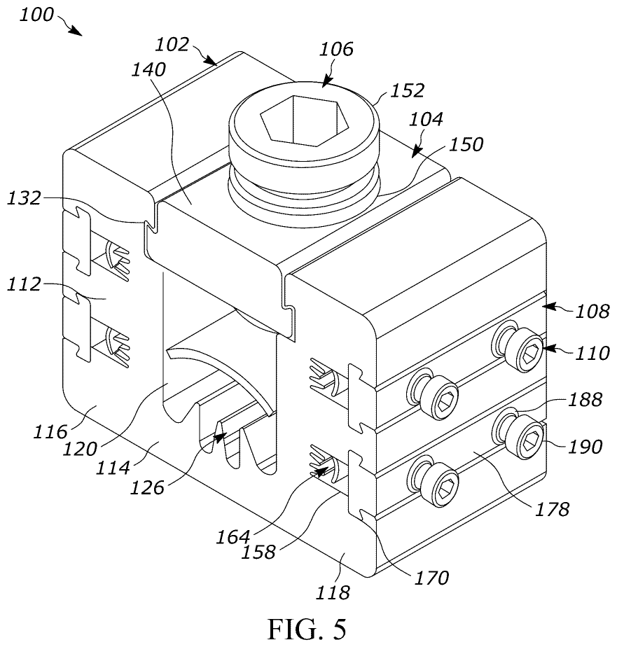

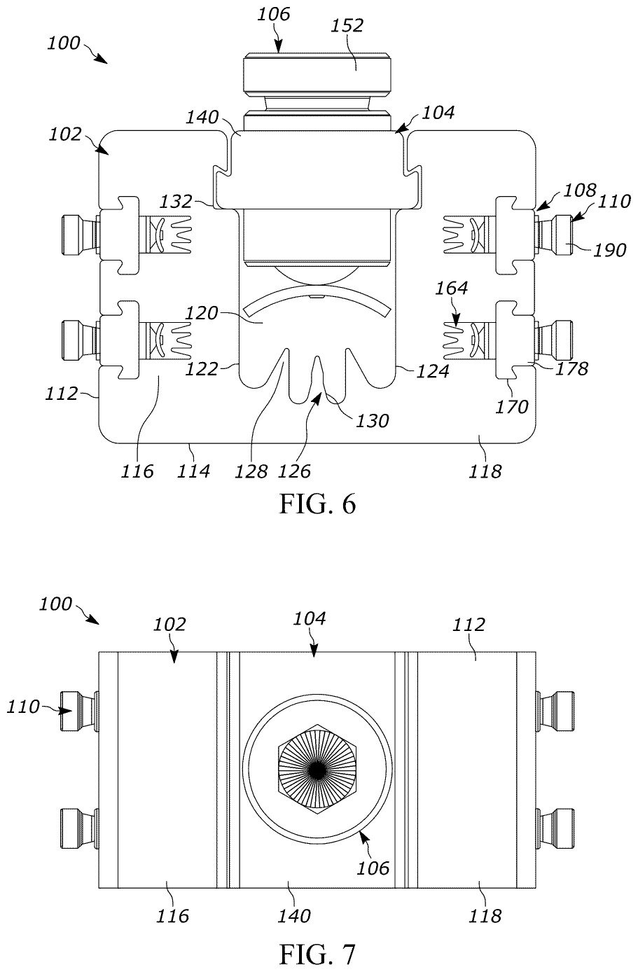

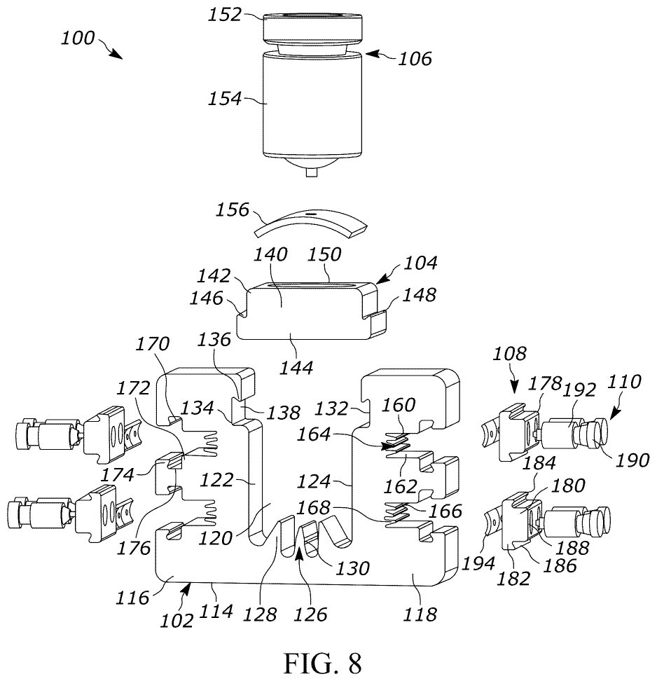

FIGS. 5-8, show an exemplary configuration of a multi-tap connector 100 having a conductor block 102, a run line cap 104, a run line bolt 106, a plurality of tap line caps 108, and a plurality of tap line bolts 110. The illustrated configuration shows a single run line cap 104 and bolt 106 and four tap line caps 108 each with two tap line bolts 110. Other configurations can utilize more or fewer run and tap lines as desired.

The conductor block 102 includes a body 112 having a substantially U-shaped configuration. The body 112 has a bottom portion 114, a first side portion 116, and a second side portion 118. A run line opening 120 is formed in the body 112 between the first side portion 116 and the second side portion 118. The run line opening 120 is configured to receive a run conductor. The size of the run line opening 120 can vary depending on the size or sizes of conductors that are to be received.

The run line opening 120 is bound on a first side by a first side wall 122 and on a second side by a second side wall 124. A set of run insulation piercing members 126 extend into the run line opening 120. The insulation piercing members 126 can be teeth, tines, or other features configured to pierce the insulating jacket of a conductor. In certain configurations, the insulation piercing members 126 include a pair of outer teeth 128 and a central tooth 130. The outer teeth 128 can extend higher than the central tooth 130 and can be angled toward the central tooth 130.

Each of the teeth 128, 130 can include an insulation piercing tip that is configured and dimensioned to pierce or cut through the insulating jacket of the run conductor to create an electrical path between the run conductor and the conductor block 102. The one or more insulation piercing members 126 may be integrally or monolithically formed into the bottom portion 114 of the conductor block 102 such that the one or more insulation piercing members 126 extend into the run opening 120.

In other configurations, the one or more insulation piercing members 126 may be attachable to the body 112 of the conductor block 102. For example, the insulation piercing members 126 can be formed as part of a removable assembly that can be mounted or secured to the body 112 of the conductor block 102. Further, the insulation piercing members 126 may be made from a different material than the body 112.

In certain implementations, performance of the insulation piercing members 126 can be improved by using a relatively harder material. The one or more insulation piercing members 126 may be made from a different material (e.g., copper, tempered aluminum, stainless steel, etc.) and secured to or attached to the conductor block 102 so that the one or more insulation piercing members 126 extend into the run opening 120.

The insulation piercing members 126 shown are having a substantially triangular configuration. However, the insulation piercing members 126 can include different shapes and sizes configured and dimensioned to pierce or cut through the insulating jacket surrounding electrical wires of the run conductor, such as one or more cone-shaped members and/or one or more members with pointed tips. Further, one or more of the insulation piercing members 126 may include serrations on one or both sides of the insulation piercing members 126.

In certain configurations, a pair of run guide slots 132 extend from the run line opening 120. The run guide slots 132 are configured to slidably receive the run line cap 104. In the illustrated configuration, the guide slots 132 include an inner wall 134, an outer wall 136, and a side wall 138. The inner wall 134 extends further into the run opening 120 than the outer wall 136. The outer wall 136 has an angled portion, forming a dovetail slot for receiving the run line cap 104 in the proper orientation.

Other configurations can utilize different sizes and shapes of guide slots, including squared and rounded configurations. Certain configurations can also utilize a unitary body where the run cap 104 is integrally formed with the conductor block.

The run line cap 104 can include a body 140 configured to mate with the run guide slots 132 and fit into the conductor block 102. In the illustrated configuration, the run line cap 104 includes an outer portion 142 and an inner portion 144. The inner portion 144 is wider than the outer portion 142 to form a first shoulder 146 and a second shoulder 148. An outer edge of the shoulders 146, 148 is angled to correspond with the angled outer wall 136 of the run guide slots 132.

The run line cap 104 slidably engages the conductor block 102 over the run line opening 120. A run bolt opening 150 is provided in the run line cap 104 to receive the run line bolt 106. The opening 150 can be threaded and sized to accommodate the bolt appropriate for the run conductor.

In certain configurations the run line bolt 106 is a shear bolt having a shearable head 152, a shank 154, and a pressure bar 156. The shank can include a thread and be threadably connected to the run line cap. The pressure bar 156 can be rotatably connected to the shank 154 and configured to engage the run conductor.

The head 152 can be connected to the shank 154 by a shearable connection. The shearable section can be a weakened area designed to break or otherwise separate once a certain torque limit is reached. The shearable section can be formed by a frangible connection such as holes or slots placed in the material or can be formed from one or more section of reduced thickness. As the fastener is rotated, the shank 154 or an associated pressure bar 156 will engage a conductor. As the fastener is tightened, the engagement with the conductor will increase the amount of torque required to further turn the fastener. Once the torque limit is reached, the head 152 will shear, separating from the shank 154. This ensures a certain connection engagement is achieved with the conductor, while also preventing overtightening that could damage the conductor. Different shear limits can be used according to different conductors.

Similar to the run line connection, the conductor block 102 can include multiple tap openings for allowing connections to be formed with tap conductors. In certain confirmations, the first side portion 116 and the second side portion 118 of the conductor block 102 each include two sets of tap line openings 158. The tap line openings 158 are bound on a first side by a first side wall 160 and on a second side by a second side wall 162. A set of tap insulation piercing members 164, extend into each of the tap line openings 158. The insulation piercing members 164 can be teeth, tines, or other features configured to pierce the insulating jacket of a conductor. In certain configurations, the insulation piercing members 164 include a pair of outer teeth 166 and a central tooth 168. The outer teeth 166 can extend farther than the central tooth 168 and can be angled toward the central tooth 168. The tap insulation piercing members 164 can have any of the same properties as the run insulation piercing members 126 described herein, including being made from different materials, having different configurations, and being formed as a separate assembly releasably connected to the conductor block 102.

A pair of tap guide slots 170 extend from each of the tap line openings 158. The tap guide slots 170 can have a similar configuration as the run guide slots 132. The tap guide slots 170 include an inner wall 172, an outer wall 174, and a side wall 176. The inner wall 172 extends further into the tap opening 158 than the outer wall 174. The outer wall 174 has an angled portion, forming a dovetail slot for receiving the tap line cap 108 in the proper orientation.

Other configurations can utilize different sizes and shapes of tap guide slots 170, including squared and rounded configurations. Fewer or more tap guide slots 170 can also be incorporated into the conductor block 102. Certain configurations can also utilize a unitary body where the tap line caps 108 are integrally formed with the conductor block 102.

The tap line caps 108 can include a body 178 configured to mate with the tap guide slots 170 and fit into the conductor block 102. In the illustrated configuration, the tap line caps 108 include an outer portion 180 and an inner portion 182. The inner portion 182 is wider than the outer portion 180 to form a first shoulder 184 and a second shoulder 186. An outer edge of the shoulders 184, 186 is angled to correspond with the angled outer wall 174 of the tap guide slots 170. The tap line caps 108 slidably engages the conductor block 102 over the tap line openings 158.

In the illustrated configuration, two bolt openings 188 are provided in each of the tap line caps 108 to receive a pair of tap line bolts 110. The openings 188 can be threaded and sized to accommodate the bolt appropriate for the tap conductor. Fewer or more tap bolt openings 188 can be used as needed. The use of two tap bolt openings 188 can allow each tap line opening 158 to receive two tap lines, one from each side. Certain configurations can utilize an internal divider, as part of the conductor block 102 or tap line caps 108, as needed, to separate each tap line opening 158 into a first and second chamber. This can help a user ensure proper seating of the tap line conductors.

Each tap line bolt 110 can include a head 190, a shank 192, and a pressure bar 194. The shank 192 can include a thread and be threadably connected to the tap line cap 108. The pressure bar 194 can be rotatably connected to the shank 192 and configured to engage the run conductor. The head 190 can be connected to the shank 192 by a shearable connection as discussed with respect to the run line shear bolt 106.

During installation, a tap conductor can be placed into a tap opening 158. The associated tap bolt 110 is then tightened by rotating the head 190 so that the tap pressure bar 194 engages the tap conductor. The tap bolt 110 is then tightened further so that the tap conductor is driven into the tap insulation piercing members 164. The insulation piercing members 164 will pierce the outer insulation of the tap conductor to form an electrical and mechanical connection with the tap conductor and the conductor block 102. At a certain point, the shear limit of the head 190 will be reached, resulting in the head 190 separating from the shank 192 and preventing overtightening. Additional tap conductors can be connected in this manner as needed. Similarly, the run conductor can be placed in the run line opening 120. The run bolt 106 is then tightened by rotating the head 152 so that the tap pressure bar 156 engages the run conductor. The run bolt 106 is then tightened further so that the run conductor is driven into the run insulation piercing members 126. The insulation piercing members 126 will pierce the outer insulation of the tap conductor to form an electrical and mechanical connection with the tap conductor and the conductor block 102. At a certain point, the shear limit of the head 152 will be reached, resulting in the head 152 separating from the shank 154 and preventing overtightening. The run and tap conductors can be connected to the conductor block 102 in this manner in any order.

The use of the shear bolts 106, 110 and the insulation piercing members 126, 164 simplifies the installation procedure and can result in a faster more repeatable connection. For example, eliminates the need to strip conductors before connection to the conductor block 102 can be eliminated and lighter tools, such as an impact driver, can be used instead of heavier crimping tools.

In certain implementations, it can be advantageous to use features of both compression style connectors and shear-bolt connectors. For example, a connector can include a first portion having a compression interface and a second portion having a mechanical interface. In some configurations, the compression interface can be used to secure the tap conductors and the mechanical interface is used to secure the run conductor. The compression interface can be compressed to secure tap conductors using one or more dies positioned in a tool.

In certain implementations, the tap lines can be pre-installed before delivery to a job site. The pre-installation can be done at a factory or other facility using a hand-held or free-standing tool or compression machine. This can allow an end user to only have to install the run line conductor at a jobsite, without having to make connections to the tap lines.

In certain configurations, the connector can have a two-piece configuration. This first piece can include a key feature that will allow it to be assembled and secured to the second piece. In certain implementations, the pieces can be secured by way of peening, pinning, mechanical fasteners, or joining. The second piece can have insulation piercing technology that allows for installers to use shearbolt technology to assembly to main trunk cable by way of impact wrench.

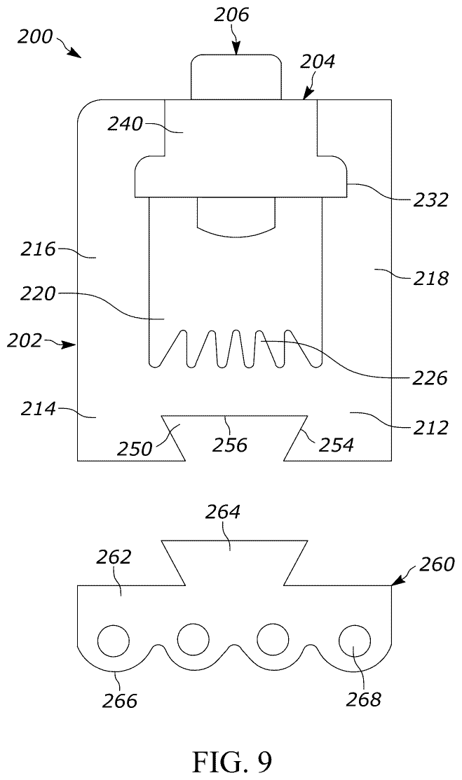

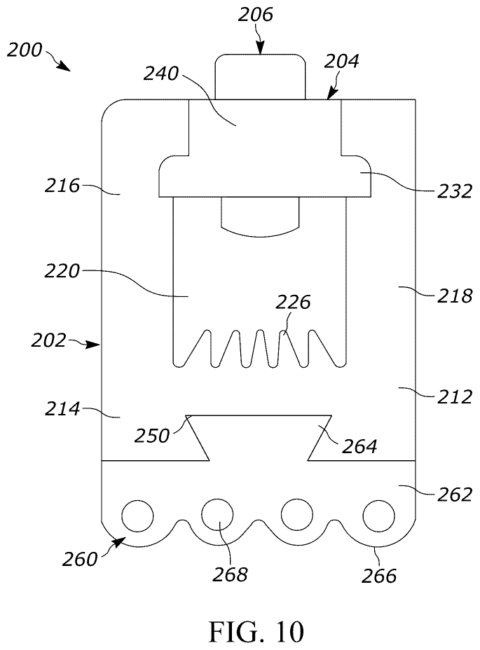

FIGS. 9 and 10 show an exemplary configuration of a multi-tap connector 200 having a conductor block 202, a run line cap 204, a run line bolt 206. The illustrated configuration shows a single run line cap 204 and bolt 206. Other configurations can utilize more or fewer run lines as desired.

The conductor block 202 includes a body 212 having a substantially U-shaped configuration. The body 212 has a bottom portion 214, a first side portion 216, and a second side portion 218. A run line opening 220 is formed in the body 212 between the first side portion 216 and the second side portion 218. The run line opening 220 is configured to receive a run conductor. The size of the run line opening 220 can vary depending on the size or sizes of conductors that are to be received.

The run line opening 220 is bound on a first side by a first side wall and on a second side by a second side wall. A set of run insulation piercing members 226 extend into the run line opening 220. The insulation piercing members 226 can be teeth, tines, or other features configured to pierce the insulating jacket of a conductor. The one or more insulation piercing members 226 can be integrally or monolithically formed into the bottom portion 214 of the conductor block 202 such that the one or more insulation piercing members 226 extend into the run opening 220.

In other configurations, the one or more insulation piercing members 226 may be attachable to the body 212 of the conductor block 202. For example, the insulation piercing members 226 can be formed as part of a removable assembly that can be mounted or secured to the body 212 of the conductor block 202. Further, the insulation piercing members 226 may be made from a different material than the body 212.

In certain configurations, a pair of run guide slots 232 extend from the run line opening 220. The run guide slots 232 are configured to slidably receive the run line cap 204. Other configurations can utilize different sizes and shapes of guide slots, including squared and rounded configurations. Certain configurations can also utilize a unitary body where the run cap 204 is integrally formed with the conductor block.

The run line cap 204 can include a body 240 configured to mate with the run guide slots 232 and fit into the conductor block 202. In the illustrated configuration, the run line cap 204 includes an outer portion and an inner portion. The inner portion is wider than the outer portion to form a first shoulder and a second shoulder.

The run line cap 204 slidably engages the conductor block 202 over the run line opening 220. A run bolt opening is provided in the run line cap 204 to receive the run line bolt 206. The opening can be threaded and sized to accommodate the bolt appropriate for the run conductor.

In certain configurations the run line bolt 206 is a shear bolt having a shearable head. The shearable section can be a weakened area designed to break or otherwise separate once a certain torque limit is reached. The shearable section can be formed by a frangible connection such as holes or slots placed in the material or can be formed from one or more section of reduced thickness. As the fastener is tightened, the engagement with the conductor will increase the amount of torque required to further turn the fastener. Once the torque limit is reached, the head will shear, separating from the shank. This ensures a certain connection engagement is achieved with the conductor, while also preventing overtightening that could damage the conductor. Different shear limits can be used according to different conductors.

In certain configurations, the bottom portion 214 of the conductor block body 212 includes a tap line engagement or mating feature. For example a slot 250 can be provided in the bottom portion 214 for slidably receiving a tap line block 260. In the illustrated configuration, the slot 250 is defined by opposing side walls 254 and an upper wall 256. The side walls 254 extend at an oblique angle relative to the upper wall 256 and toward one another into the slot 250, forming a dovetail slot for receiving the tap line block 260.

The tap line block 260 can include a body 262 configured to mate with the conductor block body 212. In certain configurations, a projection 264 can extend from an upper surface to mate with the slot 250. The projection 264 can include angled side walls configured to mate with the dovetail slot configuration. Other types of mating configurations can be used, including a reversal of the slot 250 and projection 264. In other implementations, different connections can also be used.

The tap line block 260 can include one or more raised semicircular regions or bumps 266. One or more tap conductor openings 268 are formed above each semicircular region 266. A portion of each tap conductor opening 268 can be configured and dimensioned to receive one or more tap conductors. In the illustrated configuration, the tap line block 260 includes four tap conductor openings 268. In certain configurations, one or more insulation piercing members can extend into the tap conductor openings 268 to pierce the insulation of a conductor jacket of a received conductor. Other configurations can also include teeth, ridges, and/or grooves designed to increase the hold on a stripped conductor section.

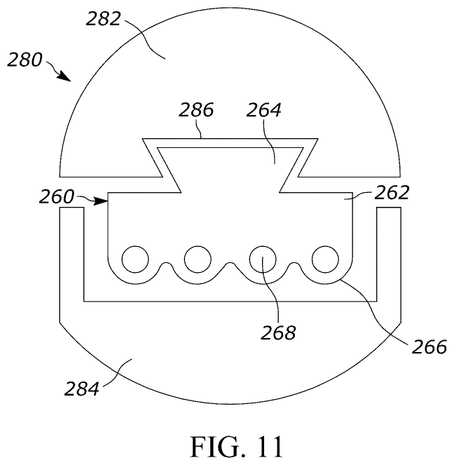

In certain operations, one or more tap conductor can be inserted into the tap conductor openings 268. The tap line block 260 can then be placed into a crimping tool 280, having an upper die 282 and a lower die 284, as shown in FIG. 11. The upper die 282 can include a slot 286 to slidably receive the projection 264 of the tap line block 260. The tap line block 260 is then compressed, deforming the semicircular regions 266 to secure the tap lines in the openings 268. In other operations, the tap line block 260 can be crimped after connecting to the conductor block 202. The tool 280 can be a manual or powered tool, such as a powered hydraulic tool. The tool 280 can also be hand-held tool or floor mounted tool.

After the tap lines are secured, the tap lines and tap line block 260 can be connected to the conductor block 202, for example by slidably engaging the projection 264 in the slot 250. In certain configurations, the tap line block 260 can then be secured to the conductor block 202. In some implementations, the tap line block 260 can be peened or further crimped to secure to the conductor block 202. In other implementations, a fastener can be used to secure the two. Alternatively or additionally, the tap line block 260 can also be configured to form a friction and/or interference fit with the conductor block 202. For example, the tap line block 260 could need to be driven into the conductor block 202 using a hammer to form an interference fit that resists removal of the tap line block 260. In some implementations, the tap lines are crimped in the tap line openings 268 while leaving the tap line block 260 removable from the run line conductor block 202.

In alternative configurations, the conductor block 202 can include one or more additional tap line openings utilizing a mechanical connector.

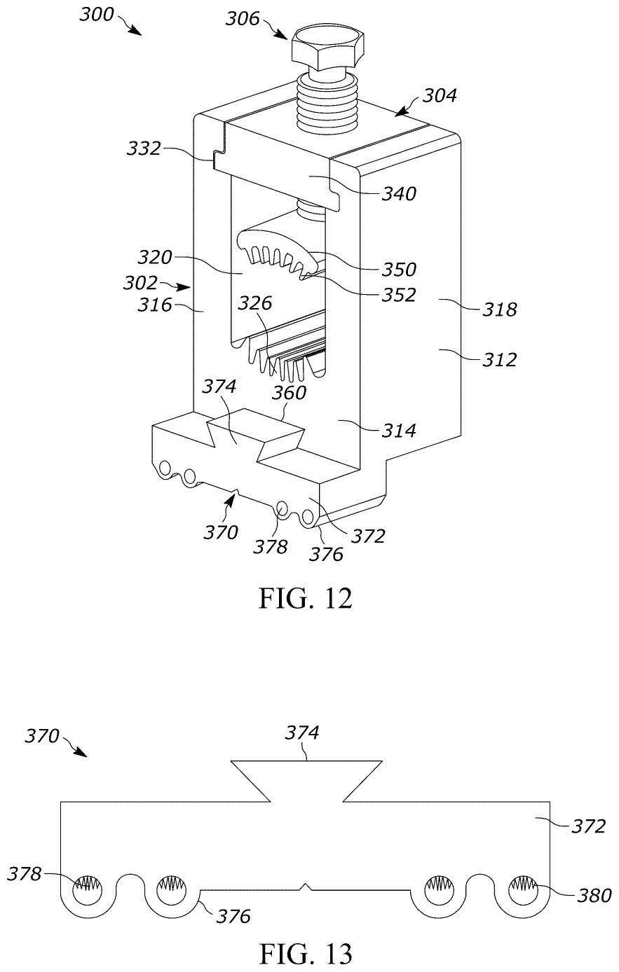

FIG. 12 shows an exemplary configuration of a multi-tap connector 300 having a conductor block 302, a run line cap 304, and a run line bolt 306. The illustrated configuration shows a single run line cap 304 and bolt 306. Other configurations can utilize more or fewer run lines as desired.

The conductor block 302 includes a body 312 having a substantially U-shaped configuration. The body 312 has a bottom portion 314, a first side portion 316, and a second side portion 318. A run line opening 320 is formed in the body 312 between the first side portion 316 and the second side portion 318. The run line opening 320 is configured to receive a run conductor. The size of the run line opening 320 can vary depending on the size or sizes of conductors that are to be received.

The run line opening 320 is bound on a first side by a first side wall and on a second side by a second side wall. A set of first run insulation piercing members 326 extend into the run line opening 320. The first insulation piercing members 326 can be teeth, tines, or other features configured to pierce the insulating jacket of a conductor. The one or more first insulation piercing members 326 can be integrally or monolithically formed into the bottom portion 314 of the conductor block 302 such that the one or more insulation piercing members 326 extend into the run opening 320.

In certain configurations, a pair of run guide slots 332 extend from the run line opening 320. The run guide slots 332 are configured to slidably receive the run line cap 304. Other configurations can utilize different sizes and shapes of guide slots, including squared and rounded configurations. Certain configurations can also utilize a unitary body where the run cap 304 is integrally formed with the conductor block.

The run line cap 304 can include a body 340 configured to mate with the run guide slots 332 and fit into the conductor block 302. In the illustrated configuration, the run line cap 304 includes an outer portion and an inner portion. The inner portion is wider than the outer portion to form a first shoulder and a second shoulder.

The run line cap 304 slidably engages the conductor block 302 over the run line opening 320. A run bolt opening is provided in the run line cap 304 to receive the run line bolt 306. The opening can be threaded and sized to accommodate the bolt appropriate for the run conductor.

In certain configurations the run line bolt 306 is a shear bolt having a shearable head. The shearable section can be a weakened area designed to break or otherwise separate once a certain torque limit is reached. The shearable section can be formed by a frangible connection such as holes or slots placed in the material or can be formed from one or more section of reduced thickness. As the fastener is tightened, the engagement with the conductor will increase the amount of torque required to further turn the fastener. Once the torque limit is reached, the head will shear, separating from the shank. This ensures a certain connection engagement is achieved with the conductor, while also preventing overtightening that could damage the conductor. Different shear limits can be used according to different conductors.

In certain configurations, the run line bolt 306 can include a pressure bar 350. The pressure bar 350 can be fixed or rotatably connected to the shank of the bolt 306 and configured to engage the run conductor. The pressure bar 350 can include a set of second insulation piercing members 352 that extend from the pressure bar 350 toward the first insulation piercing members 326 of the run line opening 320. In the illustrated configuration, the pressure bar insulation piercing members 352 include a plurality of teeth extending in an arc. Other configurations can also be used.

In certain configurations, the bottom portion 314 of the conductor block body 312 includes a tap line engagement or mating feature. For example a slot 360 can be provided in the bottom portion 314 for slidably receiving a tap line block 370. In the illustrated configuration, the slot 360 is defined by opposing side walls and an upper wall. The side walls extend at an oblique angle relative to the upper wall and toward one another into the slot 360, forming a dovetail slot for receiving the tap line block 370.

The tap line block 370 can include a body 372 configured to mate with the conductor block body 312. In certain configurations, a projection 374 can extend from an upper surface to mate with the slot 360. The projection 374 can include angled side walls configured to mate with the dovetail slot configuration. Other types of mating configurations can be used, including a reversal of the slot 360 and projection 374. In other implementations, different connections can also be used.

The tap line block 370 can include one or more raised semicircular regions or bumps 376. One or more tap conductor openings 378 are formed above each semicircular region 376. A portion of each tap conductor opening 378 can be configured and dimensioned to receive one or more tap conductors. In the illustrated configuration, the tap line block 370 includes four tap conductor openings 378. In certain configurations, the tap conductor openings 378 can be substantially hollow as shown in FIG. 12. In other configurations, one or more insulation piercing members 380 can extend into the tap conductor openings 378 to pierce the insulation of a conductor jacket of a received conductor as shown in FIG. 13. Other configurations can also include teeth, ridges, and/or grooves designed to increase the hold on a stripped conductor section.

During operation, run lines and tap lines can be connected and secured in any manner described herein.

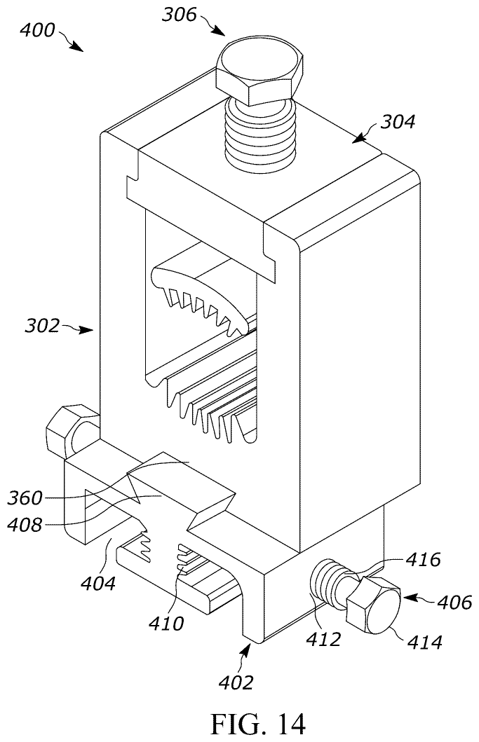

FIG. 14 shows an exemplary configuration of a multi-tap connector 400 utilizing the conductor block 302, the run line cap 304, and the run line bolt 306 shown in FIG. 12 with a tap line block 402. The tap line block 402 includes one or more tap line openings 404 and one or more tap line bolts 406. The illustrated configuration shows a single run line cap 304 and bolt 306 and two tap line openings 404 each with a single tap line bolt 406. Other configurations can utilize more or fewer run and tap lines as desired.

The tap line block 402 can include a protrusion 408 configured to mate with the lower slot 360 of the conductor block 302. The tap line openings 404 can be open to the exterior of the tap line block 402, as shown, or closed. A set of tap insulation piercing members 410 extend into each of the tap line openings 404. The insulation piercing members 410 can be teeth, tines, or other features configured to pierce the insulating jacket of a conductor.

In the illustrated configuration, a bolt opening 412 is provided in each of the tap line openings 404 to receive a pair of tap line bolts 406. The openings 412 can be threaded and sized to accommodate the bolt appropriate for the tap conductor. Fewer or more tap bolt openings 412 can be used as needed.

Each tap line bolt 406 can include a head 414 and a shank 416. The shank 416 can include a thread and be threadably connected to the tap line block 402. The head 414 can be connected to the shank 416 by a shearable connection as discussed with respect to the run line shear bolt 306.

During operation, run lines and tap lines can be connected and secured in any manner described herein.

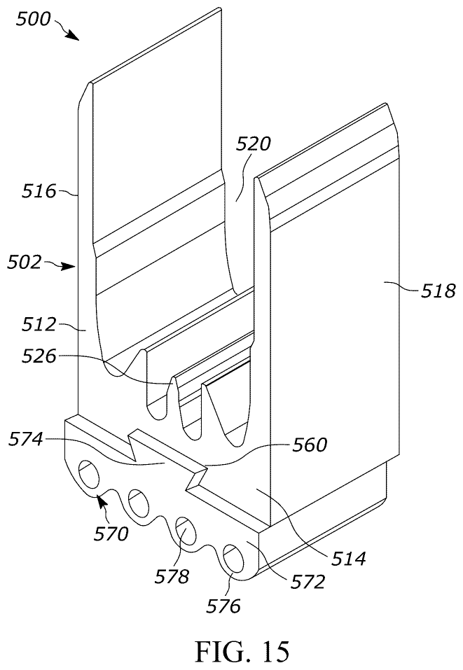

FIG. 15 shows an exemplary configuration of a multi-tap connector 500 having a compression connector 502. The compression connector 502 includes a body 512 having a substantially U-shaped configuration. The body 512 has a bottom portion 514, a first side portion 516, and a second side portion 518. A run line opening 520 is formed in the body 512 between the first side portion 516 and the second side portion 518. The run line opening 520 is configured to receive a run conductor. The size of the run line opening 520 can vary depending on the size or sizes of conductors that are to be received.

The run line opening 520 is bound on a first side by a first side wall and on a second side by a second side wall. A set of run insulation piercing members 526 extend into the run line opening 520. The insulation piercing members 526 can be teeth, tines, or other features configured to pierce the insulating jacket of a conductor. The one or more insulation piercing members 526 can be integrally or monolithically formed into the bottom portion 514 of the compression connector 502 such that the one or more insulation piercing members 526 extend into the run opening 520.

In certain configurations, the bottom portion 514 of the compression body 512 includes a tap line engagement or mating feature. For example a slot 560 can be provided in the bottom portion 514 for slidably receiving a tap line block 570. In the illustrated configuration, the slot 560 is defined by opposing side walls and an upper wall. The side walls extend at an oblique angle relative to the upper wall and toward one another into the slot 560, forming a dovetail slot for receiving the tap line block 570.

The tap line block 570 can include a body 572 configured to mate with the compression connector body 512. In certain configurations, a projection 574 can extend from an upper surface to mate with the slot 560. The projection 574 can include angled side walls configured to mate with the dovetail slot configuration. Other types of mating configurations can be used, including a reversal of the slot 560 and projection 574. In other implementations, different connections can also be used.

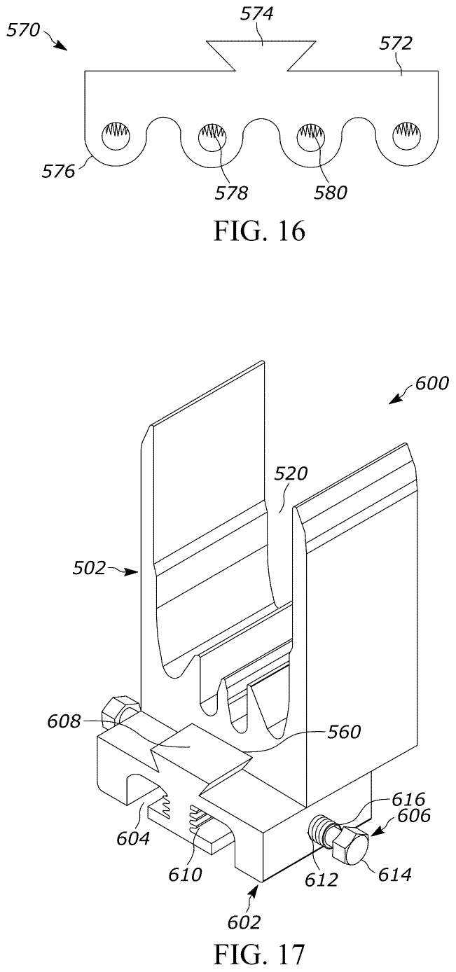

The tap line block 570 can include one or more raised semicircular regions or bumps 576. One or more tap conductor openings 578 are formed above each semicircular region 576. A portion of each tap conductor opening 578 can be configured and dimensioned to receive one or more tap conductors. In the illustrated configuration, the tap line block 570 includes four tap conductor openings 578. In certain configurations, the tap conductor openings 578 can be substantially hollow as shown in FIG. 15. In other configurations, one or more insulation piercing members 580 can extend into the tap conductor openings 578 to pierce the insulation of a conductor jacket of a received conductor as shown in FIG. 16. Other configurations can also include teeth, ridges, and/or grooves designed to increase the hold on a stripped conductor section.

During operation, run lines and tap lines can be connected and secured in any manner described herein.

FIG. 17 shows an exemplary configuration of a multi-tap connector 600 utilizing the compression connector 502 shown in FIG. 15 with a tap line block 602. The tap line block 602 includes one or more tap line openings 504 and one or more tap line bolts 606. The illustrated configuration shows two tap line openings 604 each with a single tap line bolt 606. Other configurations can utilize more or fewer run and tap lines as desired.

The tap line block 602 can include a protrusion 608 configured to mate with the lower slot 560 of the compression connector 502. The tap line openings 604 can be open to the exterior of the tap line block 602, as shown, or closed. A set of tap insulation piercing members 610 extend into each of the tap line openings 604. The insulation piercing members 610 can be teeth, tines, or other features configured to pierce the insulating jacket of a conductor.

In the illustrated configuration, a bolt opening 612 is provided in each of the tap line openings 604 to receive a pair of tap line bolts 606. The openings 612 can be threaded and sized to accommodate the bolt appropriate for the tap conductor. Fewer or more tap bolt openings 612 can be used as needed.

Each tap line bolt 606 can include a head 614 and a shank 616. The shank 616 can include a thread and be threadably connected to the tap line block 602. The head 614 can be connected to the shank 616 by a shearable connection.

During operation, run lines and tap lines can be connected and secured in any manner described herein.

The foregoing detailed description has been provided for the purpose of explaining the general principles and practical application, thereby enabling others skilled in the art to understand the disclosure for various configurations and implementations, and with various modifications as are suited to the particular uses contemplated. This description is not necessarily intended to be exhaustive or to limit the disclosure to what is disclosed. Any of the configurations and/or elements disclosed herein may be combined with one another to form various additional embodiments not specifically disclosed. Accordingly, additional configurations and implementations are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings. The words “member,” “component,” “module,” “mechanism,” “element,” “device,” and the like are not a substitute for the word “means.” As such, no claim element should be construed as a means plus function unless the element is expressly recited using the phrase “means for.”

What is claimed:

1. An electrical connector for connecting a plurality of conductors comprising:
a conductor block having a body with a run line opening and a run insulation piercing member extending into the run line opening;
a run cap extending over the run line opening;
a run bolt extending through the run cap into the run line opening; and
a tap line block connected to the conductor block, the tap line block having a tap body and a tap line opening extending at least partially through the tap body,
wherein at least a portion of the tap body is configured to be deformed to crimp a tap conductor to the tap line block.

2. The electrical connector of claim 1, wherein the run insulation piercing member is integrally formed with the conductor block.

3. The electrical connector of claim 1, wherein the run cap is removably connected to the conductor block.

4. The electrical connector of claim 1, wherein the run bolt includes a first threaded shank and a first shearable head, wherein the first shearable head is configured to disconnect from the first threaded shank on reaching a first torque limit.

5. The electrical connector of claim 1, wherein the conductor block includes a first mating feature and the tap line bock includes a second mating feature configured to mate with the first mating feature.

6. The electrical connector of claim 5, wherein the first mating feature includes a slot extending into the conductor block body.

7. The electrical connector of claim 6, wherein the slot is a dove-tail slot.

8. The electrical connector of claim 6, wherein the second mating feature includes a projection configured to slidably engage the slot.

9. The electrical connector of claim 1, wherein the tap line block is crimpable independent from the conductor block.

10. An electrical connector for connecting a plurality of conductors comprising:
a conductor block having a body with a run line opening, a run insulation piercing member extending into the run line opening;
a run cap extending over the run line opening;
a run bolt extending through the run cap into the run line opening; and
a tap line block slidably connected to the conductor block, the tap line block having a tap body and a tap line opening extending at least partially through the tap body.

11. The electrical connector of claim 10, wherein the tap line block includes a tap insulation piercing member extending into the tap line opening.

12. The electrical connector of claim 10, wherein the tap line opening is open to the exterior of the conductor block.

13. The electrical connector of claim 10, wherein at least a portion of the tap body is configured to be deformed to crimp a tap conductor to the tap line block.

14. The electrical connector of claim 10, wherein a shearable fastener extends through the tap line block and into the tap line opening.

15. The electrical connector of claim 10, wherein the run bolt includes a shearable fastener head.

16. An electrical connector for connecting a plurality of conductors comprising:
a conductor block having a body with a run line opening, a run insulation piercing member extending into the run line opening;
a run cap extending over the run line opening;
a run bolt extending through the run cap into the run line opening;
a pressure bar connected to the run bolt; and
a tap line block slidably connected to the conductor block, the tap line block having a tap body and a tap line opening extending at least partially through the tap body,
wherein at least a portion of the tap body is configured to be deformed to crimp a tap conductor to the tap line block.

17. The electrical connector of claim 16, wherein the pressure bar includes a second insulation piercing member extending into the run line opening.

18. The electrical connector of claim 16, wherein the tap line block includes a tap insulation piercing member extending into the tap line opening.

19. The electrical connector of claim 16, wherein the conductor block includes a dove-tail slot mating feature and the tap line bock includes a dove-tail projection configured to mate with the dove-tail slot.

20. The electrical connector of claim 16, wherein the run bolt includes a shearable fastener head.
